(19) United States
(12) Patent Application Publication
(10) Pub. No.: US 2020/0258179 A1
(43) Pub. Date: Aug. 13, 2020

(54) Vending of Commissary Goods Ordered via Controlled-Environment Facility Resident Communication and Media Devices

(71) Applicant: Securus Technologies, Inc., Dallas, TX (US)

(72) Inventors: Scott Passe, Forney, TX (US); Luke Keiser, Frisco, TX (US)

(73) Assignee: SECURUS TECHNOLOGIES, INC., Dallas, TX (US)

(21) Appl. No.: 14/755,033

(22) Filed: Jun. 30, 2015

(51) Int. Cl. G06Q 50/26; G06Q 30/06

(52) U.S. Cl. CPC G06Q 50/26; G06Q 30/0637

(57) ABSTRACT

Controlled-environment facility commissary goods ordering and distribution systems and methods employ controlled-environment facility resident communication and/or media devices disposed in the controlled-environment facility, which may accept an order from a resident of the controlled-environment facility for one or more commissary items and transmit the order to a controlled-environment facility vending machine disposed in the controlled-environment facility. The controlled-environment facility vending machine includes a vending mechanism configured to selectively vend selected items and a vending controller. The vending controller may accept or retrieve the order, verify the presence of the resident at the vending machine, and cause the vending mechanism to dispense item(s) in the order, to the resident.

### TECHNICAL FIELD

The present disclosure relates generally to controlled-environment facilities, more particularly to processing of electronic commissary orders in controlled-environment facilities, and specifically to distribution of commissary goods via a remote vending machine.

### BACKGROUND

In a controlled-environment facility, such as within a correctional facility, such as a prison or jail, controlling access, information, interaction, and/or transactions is often of particular interest. In a correctional facility in particular, safety and security is of paramount importance and, therefore, the number one job of the personnel thereof is to effectively implement controls with respect to the residents (inmates) thereof. However, such controlled-environment facilities often operate not unlike a small city in which a number of individuals work and live, thus requiring various goods and/or services associated with civilized society. Accordingly, various exchanges of information, money, goods, etcetera, may be performed in association with individuals of a controlled environment, both within the controlled-environment facility and external thereto.

For example, an inmate residing in a correctional facility may wish to communicate with friends and family outside of the prison facility. Likewise, an inmate may wish to acquire commissary items, such as toiletries, bed linens, clothing, and food items. However, facilitating and administrating exchanges of information, money, goods, etcetera, with respect to a controlled environment facility, such in association with each of the foregoing examples, is often costly and time consuming and may even present security and safety issues. For example, often substantial controlled environment facility personnel (e.g., guard) time is expended in scheduling visitations, conducting background checks with respect to visitors, providing information regarding visitation times and rules, etcetera. Likewise, substantial controlled environment facility personnel time is expended in taking orders for commissary items, verifying that individuals have sufficient funds to purchase commissary items, accepting and accounting for funds received from various individuals for the benefit of another individual to purchase commissary, reporting status of accounts and orders, delivering commissary orders, etcetera. Moreover, such personnel may be called upon repeatedly to perform such tasks as respond to balance inquiries, explain account deductions/credits, answering frequently asked questions, and/or the like. The time such controlled environment facility personnel dedicate to such tasks is both costly to the controlled environment facility and removes such personnel from other tasks, such as securing the facility and monitoring the activity of the population.

Moreover, such tasks as accomplished today are typically largely paper based and require appreciable manual processing, thereby further aggravating the directing of personnel's attention away from tasks more primary to the operation of the controlled environment facility and further adding to the costs. For example, appreciable resources are often involved in taking commissary orders, such as to provide updated item and price lists, order forms (e.g., SCANTRON forms), etcetera. Commissary orders are typically delivered by a designated commissary provider, which packages a resident's ordered goods and deliver them to the facility. The personnel that prepare the commissary packages are subject to background checks and are monitored to prevent contraband introduction into the facility in this manner. Prior to distribution, the orders are inspected by facility staff for potential contraband and sorted by housing unit. Accordingly, current processes for facilitating and administering exchanges of information, money, goods, etcetera, with respect to a controlled environment facility involve substantial expenses for consumable resources.

Vending machines are sometimes used in controlled-environment facilities. However, the point of sale for vending machines is typically at the vending machine itself. IP (Internet Protocol) or other network connectivity may be used to manage inventory (e.g. stock levels, etcetera) within vending machines (e.g. advise a vending machine operator of low levels of a particular item, age of items in the machine, etcetera).

### SUMMARY

The present invention is directed to systems and methods, which provide controlled-environment facility commissary goods ordering and distribution. Embodiments of the present systems and methods employ controlled-environment facility resident communication and/or media devices disposed in the controlled-environment facility, which may accept an order from a resident of the controlled-environment facility for commissary item(s) and transmit the order to a controlled-environment facility vending machine disposed in the controlled-environment facility. The controlled-environment facility vending machine includes a vending mechanism configured to selectively vend selected item(s) and a vending controller. The vending controller may accept or retrieve the order, verify the presence of the resident at the vending machine, and cause the vending mechanism to dispense item(s) from the order, to the resident.

The vending controller may accept identification information from the resident to verify the presence of the resident at the vending machine and restrict dispensing of the item(s) specified in the order, to the resident. Alternatively, or additionally, at least one radio frequency reader may be operatively coupled to the vending controller. In such embodiments, the vending controller may employ the reader to detect a Radio Frequency Identification (RFID) tag associated with the resident to verify the presence of the resident at the vending machine and restrict dispensing of the item(s) specified in the order, to the resident. This RFID tag may be disposed in an article worn by the resident. Alternatively, or additionally, the vending controller may employ near field communication to exchange data with a near field communication device associated with the resident to verify the presence of the resident at the vending machine and restrict dispensing of the item(s) specified in the order, to the resident. The near field communication device associated with the resident may be part of a personal controlled-environment facility resident communication and/or media device associated with the resident, which may or may not have been used to place the order.

In various embodiments, one or more of the techniques described herein may be performed by one or more computer systems. In other various embodiments, a tangible computer-readable storage medium may have program instructions stored thereon that, upon execution by one or more computer systems, cause the one or more computer systems to execute one or more operations disclosed herein. In yet other various embodiments, one or more systems may each include at least one processor and memory coupled to the processor(s), wherein the memory is configured to store program instructions executable by the processor(s) to cause the system(s) to execute one or more operations disclosed herein.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Having thus described the invention in general terms, reference will now be made to the accompanying drawings, which are not necessarily drawn to scale, and wherein:

FIG. 1 is a diagrammatic illustration of an example environment, wherein an example embodiment of the present systems and methods for vending commissary goods ordered via a controlled-environment facility resident communication and/or media device may be deployed, in accordance with some embodiments;

FIG. 2 is a diagrammatic illustration of an example of an intelligent facility communication device, according to some embodiments;

FIG. 3 is a diagrammatic illustration of an example intelligent resident communication and/or media device, according to some embodiments of the present systems and methods;

FIG. 4 is a diagrammatic illustration of an example vending machine configured in accordance with some embodiments of the present systems and methods;

FIG. 5 is a flowchart of an example process implementation for ordering and vending of commissary goods via a controlled-environment facility resident communication and/or media device, in accordance with some embodiments;

FIG. 6 is a block diagram of a computer system, device, station, or terminal configured to implement various techniques disclosed herein, according to some embodiments.

While this specification provides several embodiments and illustrative drawings, a person of ordinary skill in the art will recognize that the present specification is not limited only to the embodiments or drawings described. It should be understood that the drawings and detailed description are not intended to limit the specification to the particular form disclosed, but, on the contrary, the intention is to cover all modifications, equivalents and alternatives falling within the spirit and scope of the claims. As used herein, the word “may” is meant to convey a permissive sense (i.e., meaning “having the potential to”), rather than a mandatory sense (i.e., meaning “must”). Similarly, the words “include,” “including,” and “includes” mean “including, but not limited to.”

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

For example, various types of controlled-environment facilities are present in today's society, and persons may be voluntary or involuntary residents of such facilities, whether temporarily or permanently. Examples of controlled-environment facilities may include correctional institutions (e.g., municipal jails, county jails, state prisons, federal prisons, military stockades, juvenile facilities, detention camps, home incarceration environments, etcetera), healthcare facilities (e.g., hospitals, nursing homes, mental health facilities, rehabilitation facilities, such as drug and alcohol rehabilitation facilities, etcetera), restricted living quarters (e.g., hotels, resorts, camps, dormitories, barracks, etcetera), and the like. For convenience of explanation, various examples discussed herein are presented in the context of correctional facilities, or the like. For instance, in some of the embodiments discussed below, a controlled-environment facility may be referred to as a correctional facility, jail or prison, and its residents may be referred to as inmates, arrestees, or detainees. It should be understood, however, that the systems and methods described herein may be similarly applicable to other types of controlled-environment facilities and their respective residents (e.g., a hospital and its patients, a school dormitory and its students, etcetera).

The present disclosure relates generally to controlled-environment facilities, more particularly to processing of electronic commissary orders in controlled-environment facilities, and specifically to distribution of commissary goods via a remote vending machine. In accordance with embodiments of the present systems and methods, controlled-environment facility commissary goods ordering and distribution employs controlled-environment facility resident communication and/or media devices disposed in the controlled-environment facility, which may accept an order from a resident of the controlled-environment facility for one or more commissary items and transmit the order to a controlled-environment facility vending machine that is disposed in the controlled-environment facility. The controlled-environment facility vending machine includes a vending mechanism configured to selectively vend selected items and a vending controller. The vending controller may accept or retrieve the order, verify the presence of the resident at the vending machine, and cause the vending mechanism to dispense item(s) in the order, to the resident.

Hence, in accordance with embodiments of the present systems and methods, an intelligent vending machine employs a point of sale located remotely from the vending machine. The point of sale for the items vended might be an Intelligent Facility Device (IFD), an Intelligent Resident Device (IRD) or a similar controlled-environment facility resident communication and/or media device. A complete (paperless) transaction may be initiated at the controlled-environment facility resident communication and/or media device, and the item purchased may be “picked up” at the vending machine at a later time. In accordance with such embodiments, an automated commissary system may manage funds collection, account balances etcetera. When the item purchased is actually “vended” to the resident, the transaction is completed.

Embodiments of the present systems and methods address “commissary day” problems. For example, facility personnel may be stretched thin in order to distribute, or at least oversee distribution of, commissary orders. Also, general confusion associated with the disruption of daily routine, may accompany the distribution of commissary orders. Another issue that arises from “commissary day” is that it often creates issues of theft between inmates. That is the distribution of large quantities of items can lead to theft. These or other commissary day issues may result in security risks or concerns, etcetera.

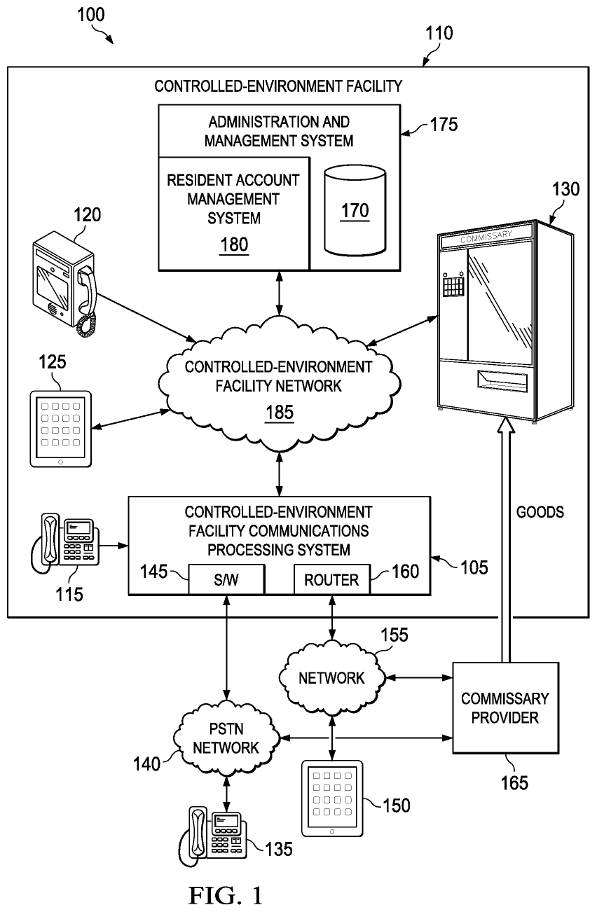

FIG. 1 is a diagrammatic illustration of example environment 100, wherein an example embodiment of the present systems and methods for vending commissary goods ordered via a controlled-environment facility resident communication and/or media device may be deployed, in accordance with some embodiments. Communication processing system 105 may provide telephone services, videoconferencing, online chat, and other communication services to residents of controlled-environment facility 110. In some cases, such as illustrated, communication system 105 may be co-located with controlled-environment facility 110. Alternatively, communication system 105 may be centrally or remotely located with respect to one or more controlled-environment facilities and/or may provide communication services to multiple controlled-environment facilities. More generally, however, it should be noted that communication system 105 may assume a variety of forms, and may be configured to serve a variety of facilities and/or users, whether within or outside of a controlled-environment facility.

Residents may use more-or-less conventional telephones 115 to access certain communication services. However, in accordance with embodiments of the present systems and methods, residents may also use a controlled-environment communication and/or media device or the like. For example, a resident may use a video communication device 120, or the like, to place voice calls, as well as for video communication. Such a video communication device may be referred to as an Intelligent Facility Device (IFD), which may be a videophone particularly adapted for use in a controlled-environment facility. Generally speaking, multiple video communication devices/IFDs 120 are disposed in a controlled-environment facility, and may be disposed in a visitation room, in a pod, as part of a kiosk, etcetera. Additionally or alternatively, in accordance with embodiments of the present systems and methods, personal computer wireless devices, such as a tablet computing device or smartphone (125), which may have been adapted and/or approved for use in controlled-environment facility, may be used by controlled-environment facility residents for communication. Such a device may be referred to as an Intelligent Inmate Device (IID) in a correctional institution environment, and/or an Intelligent Resident Device (IRD), or the like, in controlled-environment facilities, in general. As will be appreciated, IFD 120, IRD 125, or other similar devices have video conferencing capabilities, or the like, to enable a party to participate in video communication sessions with other call parties, such as non-residents of the controlled-environment facility, via video communication, secure online chat, etcetera. Regardless, IFDs, IIDs, IRDs, etcetera, may be generally referred to herein as a controlled-environment communication and/or media device, or the like.

In accordance with embodiments of the present systems and methods, controlled-environment communication and/or media devices (120 and 125) may be used to place commissary orders and such orders may at least in part be delivered via controlled-environment facility vending machine 130. That is, an IFD or IRD can be used as a point of sale for commissary. However, traditionally, delivery of items requires personnel to actually transport items to the controlled-environment facility and deliver the items to residents. As noted, vending machines may use IP or other connectivity for maintenance and supply purposes. However, in accordance with embodiments of the present systems and methods, the point of sale may be IFD 120 or IRD 125 and on-site vending machine 130 may provide the ordered product(s). That is, vending machine 130 may act as the point of delivery, in accordance with embodiments of the present systems and methods. In accordance with some such embodiments, these transactions may be paperless.

In various embodiments, video communication devices, IFDs 120, may be implemented as a computer-based system. For example, each of IFD 120 may include a display, camera, and handset. The display may be any suitable electronic display such as, for example, a Liquid Crystal Display (LCD), a touchscreen display (e.g., resistive, capacitive, etcetera), or the like, whereas the camera may be any suitable imaging device such as, for instance, a video camera or webcam equipped with Charge-Coupled Devices (CCDs), Complementary Metal-Oxide-Semiconductor (CMOS) active pixel sensors, etcetera. A handset may be similar to a traditional telephone handset including an earpiece portion (with a loudspeaker), a handle portion, and a mouthpiece portion (with a microphone). During a video communication session, IFD 120 may be configured to capture a video image of a resident to be transmitted to a non-resident using the camera, and to display a video image of the non-resident to the resident using the display. IFD 120 may also be configured to capture an audio signal from the resident to be transmitted to a non-resident using the mouthpiece portion of the handset, and to provide an audio signal from the non-resident to the resident using the earpiece portion of the handset. Additionally or alternatively, audio received from the non-resident may be reproduced via a loudspeaker, and audio provided by the resident may be captured via a microphone. In some cases, IFD 120 may assume the form of any computer, tablet computer, smart phone, etcetera, or any other consumer device or appliance with videoconferencing capabilities. For example, in a correctional facility environment a tablet computing device may be mounted on a wall, in a hardened case, as a video communication device or IFD.

IRDs 125 may be a personal controlled-environment facility resident communication and/or media device, such as a tablet computing devices, smartphones, media players, or the like adapted and/or approved for use by residents of the controlled-environment facility (within the controlled-environment facility). Each IRD 125 may be particularly adapted for use in a controlled-environment. For example, in a correctional institution, jail, or the like, such an IRD, or IID, may have a specially adapted operating system and/or may be “stripped-down,” particularly from the standpoint of what apps and/or hardware are provided or allowed on IRD 125, and/or connectivity afforded such a IRD. For example, such an IRD may employ an operating system kernel such one based upon an open source platform such as the CyanogenMod-based operating system, which may be built for use in such an IRD in a controlled-environment facility. As a further example, the IRD may be adapted to only connect to a network provided by the controlled-environment facility, and/or in only certain locations, within the controlled-environment facility, such as may be controlled by availability of Wi-Fi access, or the like, only being available in certain areas. That is, for example, where streaming and/or downloading may be compartmentalized, leveraging the structure of the controlled-environment facility, for example, limiting the availability of a Wi-Fi signal, providing the stream through the placement of wireless access points, antenna directionality of such wireless access points, and/or the like. Further, the IRD may allow access to apps or content only upon application of security measures, by the IRD. Such security measures may include determining, by the IRD, DNS spoofing, DNS redirection, use of proxy servers for privacy and security, biometric validation, password validation, and/or the like. Also, In accordance with embodiments of the present systems and methods, the IRD may have a few fixed apps pre-installed on the device, and installation of further apps on the device may be forbidden (i.e. prevented by modifications to the device's operating system, or the like) and/or restricted, such as by requiring permission from a facility administrator, or the like. Apps provided on IRDs might include apps of particular interest to residents of the controlled-environment facility. For example, IRDs provided to inmates of correctional facilities, might include apps that may be of particular use to an inmate, in general, such as a commissary ordering app, access to a legal research service, or of more specific interest, such as providing an inmate nearing release, access to employment searching apps or the like. Hence, such inmate IRDs (IIDs) may be used to help soon to be released inmates transition. For example, the IID may be used to communicate with a future employer, or the like. As such, IIDs may be sponsored, or otherwise subsidized by organizations or companies, assisting with the transition of inmates into society, selling commissary goods, or the like.

In various embodiments, to access communication services, a resident may initiate telephone services by lifting the receiver on telephone 115 or IFD 120, and/or otherwise initiating a call, such as by launching a communications application program (app) on IRD 125. At which time, the resident may be prompted to provide a personal identification number (PIN), other identifying information or biometrics. An interactive voice response (IVR) unit (not shown, but which may be integrated into communication processing system 105) may generate and play a prompt, or other messages, to the resident on device 115, 120 or 125. Under the control of communication processing system 105, devices 115, 120 and 125 may be capable of connecting to a non-resident's (i.e., a person not incarcerated or otherwise committed to a controlled-environment facility) telephone 135 across a publicly switched telephone network (PSTN) 140. For example, telephone 140 may be located at a non-resident's home or office, at a resident visitation center, etcetera. Switch 145, in communication processing system 105, may be used to connect calls across PSTN 140. Additionally or alternatively, the non-resident may communicate using device 150, which may be a mobile phone, tablet computing device, personal computer, or the like, which may be connected through an Integrated Services Digital Network (ISDN), Voice-over-IP (VoIP), or packet data network (such as, for example the Internet), a wireless communications network, or the like 155. Router 160 of communication processing system 105 is used to route data packets associated with a call connection to device 150. For example, a non-resident party may have a device 150 with a built-in front-facing camera, or the like, and an integrated display (e.g., a smart phone, tablet, etcetera, as illustrated), a personal computer with a webcam, etcetera. A network connection between the parties may be established and supported by an organization or commercial service that provides computer services and software for use in telecommunications and/or VOIP, such as SKYPE®. Additionally or alternatively, the correctional facility and/or the destination may use videoconferencing equipment compatible with ITU H.323, H.320, H.264, and/or V.80, or other suitable standards.

In accordance with some embodiments of the present systems and methods, pop-ups may be provided during a video call (or an audio call) to sell commissary items. Further, in accordance with such embodiments, and/or further embodiments non-residents may be afforded an opportunity to purchase commissary goods for a resident, which may, in turn be vended by vending machine 130, in accordance with embodiments of the present systems and methods.

Further, communication out of facility 110 may be directed to a commissary provider/vendor 165 that supplies commissary goods to residents of controlled-environment facility 110, such as, at least in part, through stocking of vending machine 130. These communications may take the form of orders to be vended in accordance with embodiments of the present systems and methods, vending machine telemetry with respect to operational aspects of vending machine 130, inventory levels, and/or the like.

In addition to providing certain visitation and communication operations, communication processing system 105 may attempt to ensure that a resident's calls, video conferences, online chats, etcetera, are performed only with non-residents whose identities, devices, email addresses, phone numbers, etcetera, are listed in that resident's Pre-Approved Contact (PAC) list. Each resident's PAC list may be stored, for example, in database 170 maintained by controlled-environment Administration and Management System (AMS) 175. In addition to PAC list(s), AMS 175 may also store Resident Profile Data (RPD), as well as communication and/or visitation rules applicable to each resident. As an example, in the context of a correctional facility, AMS 175 may be referred to as a Jail Management System (JMS). Within the AMS or JMS 175, database 170 may include information such as balances for resident trust, commissary and calling accounts; trial schedule; conviction data; criminal record; sentencing data, such as time served, time remaining to be served, and release date; cell and cellmate assignments; resident restrictions and warnings; commissary order history; telephone call history; call recordings; known or suspected gang or criminal affiliations; known or suspected affiliates, accomplices, or gang members; and any other information that may be relevant or useful to correctional facility staff to house and maintain residents. Controlled-environment facility resident account management system 180, which may be a separate system, or which may be a part or function of AMS 175, as illustrated, may maintain resident accounts to the benefit of the respective resident, such as resident communications accounts, commissary accounts, trust accounts, or the like, which may be used to pay for communications, commissary goods, or the like. The communications accounts may in some embodiments, include community communications accounts maintained by controlled-environment facility resident account management system 180, administration and management system 175, and/or the like, of at least one controlled-environment facility, to the benefit of a number of residents of the same of different facilities for payment of communications.

In some implementations, communication processing system 105 may be configured to perform video communication monitoring operations configured to monitor and or record video communication sessions (e.g., as electronic video files). In scenarios where communication processing system 105 is located within the controlled-environment facility, it may have direct access to AMS or JMS 175. In other embodiments, however, communication processing system 105 may be located remotely with respect to the controlled-environment facility, and access to AMS or JMS 175 may be obtained via a computer network such as, for example, network 155.

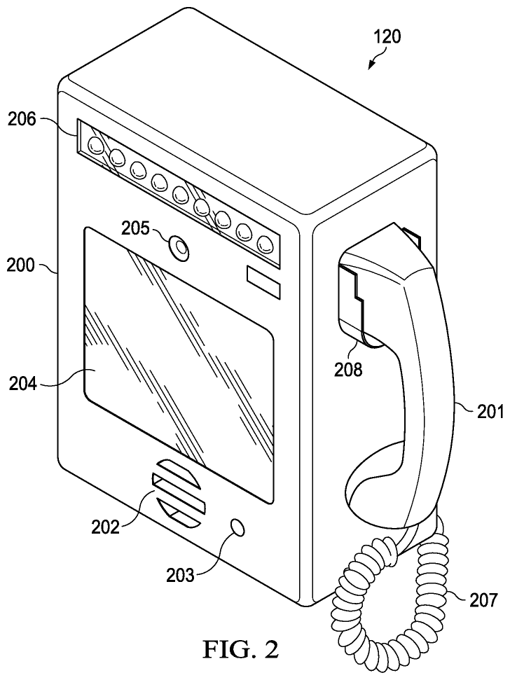

FIG. 2 is a diagrammatic illustration of an example intelligent facility (communication) device, IFD 120, according to some embodiments. In some embodiments, device 120 may be implemented as a computer-based system such as described in connection with FIG. 6. Also, in some implementations, IFD 120 may be located in a pod, which is a separate and self-contained housing unit within a correctional facility designed to hold a number of inmates (e.g., ˜12 to 50 prisoners). A small number of prison officers (e.g., ˜2 or 3), and sometimes a single officer or other facility personnel, supervise each pod. Each pod may contain tiers of cells arranged around a central control station or desk from which a single officer can monitor all the cells and the entire pod, control cell doors, and communicate with the rest of the inmates. Additionally or alternatively, IFD 120 may be disposed in a visitation area of the correctional facility. In other embodiments, IFD 120 may be disposed outside of the correctional facility or within a sleeping area, such as in a cell.

As illustrated, device 120 includes display 204, camera 205, and handset 201 coupled to device 120 via wire 207. Display 204 may be any suitable electronic display such as, for example, a Liquid Crystal Display (LCD), a touchscreen display (e.g., resistive, capacitive, etcetera), or the like, whereas camera 205 may be a suitable imaging device such as, for instance, a video camera or webcam equipped with Charge-Coupled Devices (CCDs), Complementary Metal-Oxide-Semiconductor (CMOS) active pixel sensors, etcetera. Some IFDs may employ light sources for enabling capture of conventional images and/or video, such as light module 206. Handset 201 may be similar to a traditional telephone handset including an earpiece portion (with a loudspeaker), a handle portion, and a mouthpiece portion (with a microphone).

During a video visitation session, IFD 120 may be configured to capture a video image of an inmate to be transmitted to a non-resident using camera 205, and to display a video image of the non-resident to the inmate using display 204. IFD 120 may also be configured to capture an audio signal from the inmate to be transmitted to the non-resident using the mouthpiece portion of handset 201, and to provide an audio signal from the non-resident to the inmate using the earpiece portion of handset 201. Additionally or alternatively, audio received from the non-resident may be reproduced via loudspeaker 202, and audio provided by the inmate may be captured via microphone 203. In some embodiments, handset holder or holster 208 may be configured to allow a user to securely rest handset 201 against device 120 (e.g., in the “on hook” position) when device 120 is not in use. Furthermore, handset holder 208 may include a mechanical or electromechanical switch or sensor (not shown) that senses when handset 201 is its not resting against it (e.g. in the “off hook” position).

It should be noted that, outside of correctional facilities, IFD 120 might assume the form of any computer, tablet computer, smart phone, etcetera, or any other consumer device or appliance with videoconferencing capabilities. Meanwhile, in the context of correctional facilities, IFD 120 may include one or more tampering/impact resistant or hardened elements configured to protect them from vandalism or otherwise destructive acts. For example, one or more of elements 202 through 206 may be protected by a transparent plastic or thermoplastic (e.g., Plexiglas, etcetera) material.

In addition video and/or audio communications IFD 120 may also provide an interface that a resident may use for various purposes, such as ordering commissary goods or other services. In accordance with embodiments of the present systems and methods and as discussed in greater detail below, a resident may place an order on IFD 120 which is then forwarded, or otherwise routed, to vending machine 130, where the ordering resident may pickup some or all of the goods ordered.

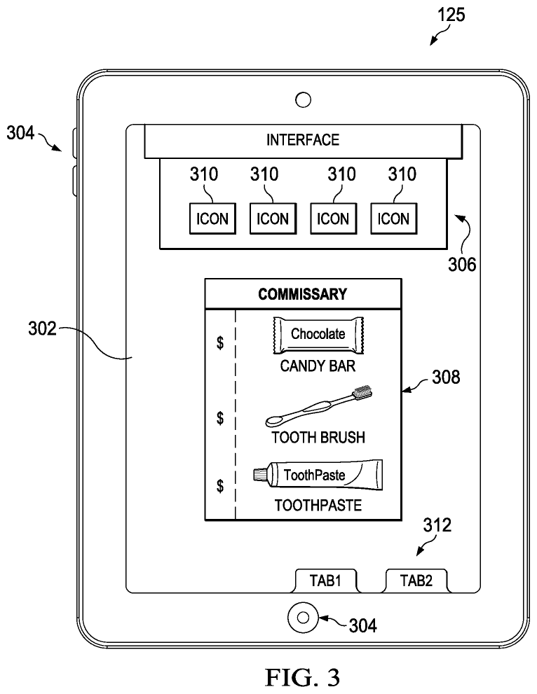

FIG. 3 is a diagrammatic illustration of example intelligent resident (communication and/or media) device 125, according to some embodiments of the present systems and methods. IRD 125 includes screen 302 and one or more hardware buttons 304. Interface 306 may provide access to a number of apps such as a commissary ordering app 308 shown open in FIG. 3. For example, apps available for use by a resident of the controlled-environment facility who is operating the controlled-environment communication and/or media device may be presented via the controlled-environment facility resident interface at 306, such as via icons 310. A similar interface may be available on IFD 120. Alternatively, or additionally, commissary ordering, such as in accordance with embodiments of the present systems and methods, may be incorporated into interface 306 itself. One or more tabs 312 may be displayed in interface 306 indicating open apps. In accordance with embodiments of the present systems and methods and as discussed in greater detail below, a resident may place an order on IRD 125, such as through commissary app 308, which is then forwarded, or otherwise routed, to vending machine 130, where the ordering resident may pickup some or all of the goods ordered.

Products ordered via IFD 120 and/or IRD 125 may be “credited into” vending machine 130, such as to facilitate walk-up vending of the product, as described below. Alternatively, or additionally such as for purposes of ensuring delivery, the vending machine may “communicate out,” that is, inquire upon the resident approaching the machine or identifying him or herself to the machine, from a central order processing system or the like, such as communications processing system 105, commissary provider 165, AMS 175, resident account management system 180, and/or the like, as to whether (a) product(s) are “owed” to the identified resident.

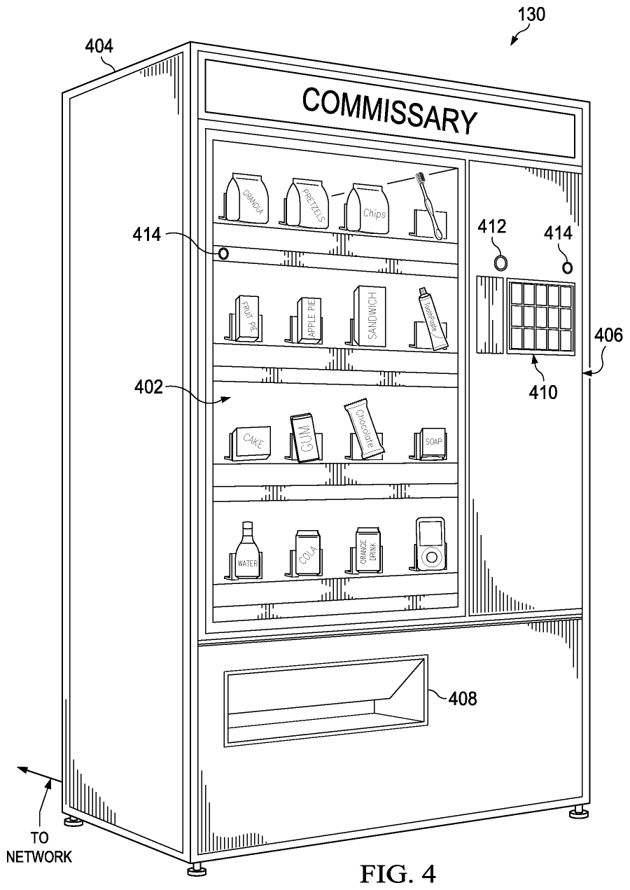

FIG. 4 is a diagrammatic illustration of example vending machine 130, configured in accordance with some embodiments of the present systems and methods. As noted, controlled-environment facility vending machine 130, which might be referred to as an intelligent dispensing machine, or the like, is disposed in controlled-environment facility 110, and may, in accordance with embodiments of the present systems and methods, function as a point of delivery for commissary goods. Controlled-environment facility vending machine 130 includes a vending mechanism, generally indicated as 402, within vending machine housing 404. Mechanism 402 is configured to selectively dispense a selected commissary item for a plurality of different commissar items under control of a vending controller, generally indicated as 406. Housing 404 may be hardened and/or reinforced for use in some controlled-environment facilities, such as correctional institutions. Vending machine 130 may be stocked with a plurality of a number of different commissary items allowed to residents of controlled-environment facility 110, such as hygiene items, snacks, bed linens, clothing, etcetera.

As noted, controlled-environment facility vending machine 130 includes vending controller 406. This vending controller may take the place of a more convention electric control for a vending machine, and/or may be adapted from such a controller. Regardless, the vending controller includes at least one processor and a memory coupled to the processor(s). The memory is configured to store program instructions executable by the processor(s) to control operation of the vending controller, and therethrough operation of vending machine 130. In accordance with embodiments of the present systems and methods, vending controller 406 accepts, or otherwise retrieves an order from a resident of a controlled-environment facility. This order is, in accordance with various embodiments of the present systems and methods placed via a controlled-environment facility resident communication and/or media device (e.g. IFD 120 or IRD 125). This order may be provided to vending machine controller 406 more-or-less directly, via internal controlled-environment facility network 185, which may be wired or wireless local area network, or the like.

The vending machine may “sense” the resident and vend the ordered product(s). That is to say, the vending machine may employ a Radio Frequency Identification (RFID) technology, near field communication technology, or the like to detect an ordering resident's RFID bracelet, IRD, or the like and vend the product(s) when it is determined the resident is immediately adjacent (and/or in front of) the vending machine, and hence in position to retrieve the product(s) from a vending slot 408, or the like. Alternatively, or additionally, the resident may identify himself to the vending machine, such as through entry of identification information, such as a number associated with the resident, a Personal Identification Number (PIN), scanning a picture ID or a barcode, providing a fingerprint, an iris scan, or any other biometric identifier. Thus, in accordance with embodiments of the present systems and methods, vending controller 406 verifies the presence of the resident at the vending machine and causes the vending mechanism to dispense one or more items specified in the order, to the resident.

In accordance with some embodiments, rather than receiving the order (directly) from the controlled-environment facility resident communication and/or media device 120 or 125, vending controller 406 may retrieve of otherwise confirm the order, upon verification of the presence of the resident at the controlled-environment facility vending machine. For example, upon detection and identification of a resident at the vending machine, the vending controller may inquire with or through communications processing system 105, system(s) of commissary provider 165, AMS 175, resident account management system 180, and/or the like, as to whether the resident is “owed” any commissary items from vending machine 130.

As noted, the vending controller may accept identification information from the resident, such as may be entered via keypad 410 to verify the presence of the resident at the vending machine and restrict dispensing of the item(s) specified in the order to only be dispensed to the resident who ordered them. In addition to facilitating identification number input, or the like keypad 410 may require the inmate to present a fingerprint, voice scan, iris scan, or other forms of biometric identification. Camera 412, which may be associated with keypad 410, as illustrated, or otherwise situated, may be used for identification of the resident for verification of the resident's presence at the vending machine 130 and/or for producing a photographic record of the transaction (i.e. dispensing of items ordered). Alternatively, or additionally, controlled-environment facility vending machine 130 may include one or more radio frequency sensors or readers, generally indicated as readers 414, operatively coupled to vending controller 406. The vending controller may employ the reader(s) to detect an RFID tag associated with the resident in order to verify the presence of the resident at the vending machine and/or to restrict dispensing of the item(s) specified in the order to only the ordering resident. In various embodiments, this RFID tag is disposed in an item worn by the resident, such as a wrist bracelet, and ankle bracelet, clothing, etcetera, which the resident may place in close proximity of reader(s) 414. Some embodiments of a controlled-environment facility vending machine controller may include a near field communication device and/or near field communication functionality. In such embodiments, the vending controller may employ the near field communication device and/or functionality to exchange data with a near field communication device and/or functionality associated with the resident to verify the presence of the resident at the vending machine and restrict vending of items specified in the order to only be to the resident. This near field communication device and/or functionality associated with the resident may be part of a personal controlled-environment facility resident communication and/or media device associated with the resident, which may or may not have been used to place the order being vended. In accordance with some embodiments of the present systems and methods, more than one RFID reader 414 or near field communications device/antenna may be disposed in the vending machine, such as spaced apart on either side at the face of the machine, to further facilitate or confirm detection of the resident at the machine, such as in front of the machine, (i.e. “between” the readers/devices).

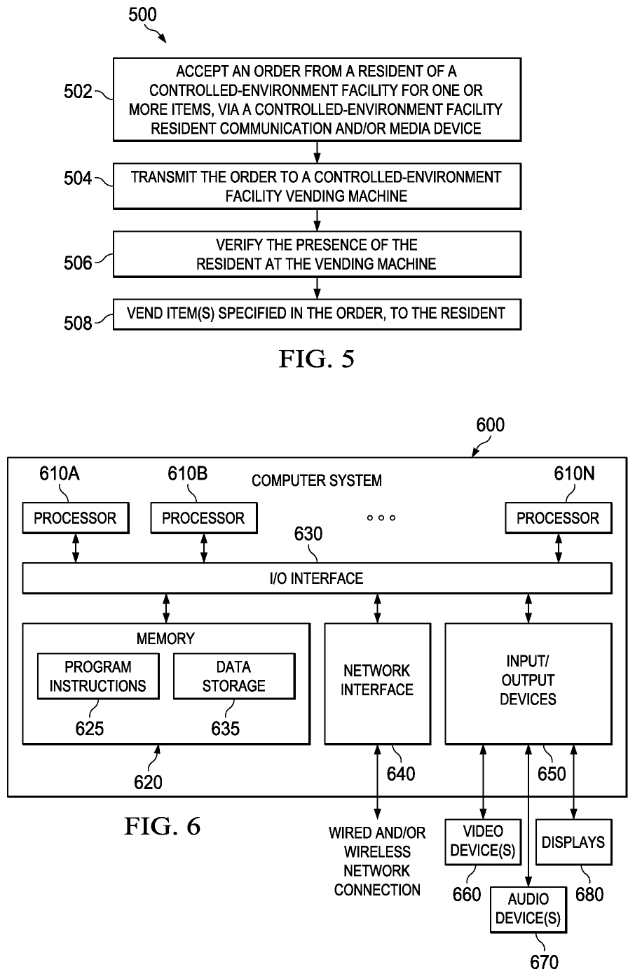

FIG. 5 is a flowchart of example process implementation 500 for ordering and vending of commissary goods via a controlled-environment facility resident communication and/or media device, in accordance with some embodiments. Implementation 500 vends one or more selected items from a plurality of different items stocked in a controlled-environment facility vending machine (130) to residents of a controlled-environment facility (110), thereby distributing commissary goods to residents of the controlled-environment facility, such as through control of operation of the vending machine in the controlled-environment facility. In implementation 500, a controlled-environment facility resident communication and/or media device (120 or 125) or the like accepts an order from a resident of the controlled-environment facility at 502, for one or more items of the plurality of different items. At 504, the order is transmitted, such as at least in part by the controlled-environment facility resident communication and/or media device (120 or 125), to the controlled-environment facility vending machine (130). Presence of the resident at the controlled-environment facility vending machine (130) may be verified at 506, by the controlled-environment facility vending machine itself. For example, as discussed above, the vending machine (130) may accept identification information from the resident, employ RFID reader(s) (414) to detect an RFID tag associated with the resident, employ near field communication device and/or functionality to exchange data with a near field communication device and/or functionality associated with the resident, or the like, to verify the presence of the resident at the vending machine at 506 and restrict vending of items specified in the order to only be to the resident. As further noted, in accordance with some embodiments, more than one RFID reader, near field communications device, or the like may be disposed in the vending machine, spaced apart, so as to enable triangulation or the like of the resident at the machine, such as in front of the machine. Regardless, at 508, the controlled-environment facility vending machine vends the one or more items specified in the order, to the resident verified as present at the machine (at 506).

Hence, in operation under various embodiments and implementations, a controlled-environment facility commissary goods order and distribution system may include at least one controlled-environment facility resident communication and/or media device, such as IFD 120 or IRD 125, disposed in controlled-environment facility 110. This controlled-environment facility resident communication and/or media device (120 or 125) may accept (at 502) an order from a resident of controlled-environment facility 110 for one or more items of a plurality of different items and transmit the order to controlled-environment facility vending machine 130 disposed in controlled-environment facility 110. During placement of the order, the availability of the item(s) ordered may be indicated. For example, commissary ordering interface 308, or the like, on the controlled-environment facility resident communication and/or media device (IFD 120 or IRD 125) may indicate whether the desired item(s) is (are) available for immediate pick-up at vending machine 130 in the controlled-environment facility 110 (and accessible to the resident (i.e. located in the resident's pod or cell block in correctional institution implementations)) available for a next commissary order delivery, backordered, or the like. As noted, controlled-environment facility vending machine 130 may include vending mechanism 402 configured to selectively vend a selected item from the plurality of items, and a vending controller 406. As also noted, this vending controller may accept or retrieve the order (at 504), verify presence of the ordering resident at the vending machine (at 506), and cause the vending mechanism to dispense item(s) in the order, to the resident (at 508). A network (185), such as a wired or wireless local area network within controlled-environment facility 110 may enable transmission of the order from the controlled-environment facility resident communication and/or media device (120 or 125) to the vending machine controller (406), via the network, directly and/or through communications processing system 105, commissary provider 165, AMS 175, resident account management system 180, and/or other comparable systems.

As will be appreciated, embodiments of the present systems and methods enable pre-ordering of goods using the controlled-environment facility resident communication and/or media device, to be retrieved later from a vending machine. Further in this regard the resident may schedule (reoccurring) orders of a particular item to be picked-up from a vending machine, on a regular basis, in accordance with some embodiments of the present systems and methods.

As will be appreciated, at least some elements of various embodiments of the present systems and methods may be implemented in software such as may variously be hosted to one degree or another by controlled-environment facility resident communication and/or media devices (IFDs 120 and/or IRDs 125), communication processing system 105, system of commissary provider 165, AMS 175, resident account management system 180, vending machine 130 (vending controller 406), and/or other system elements or components.

FIG. 6 is a block diagram of a computer system, device, station, or terminal configured to implement various techniques disclosed herein, according to some embodiments. Embodiments of the present systems and methods for vending of commissary goods ordered via controlled-environment facility resident communication and/or media devices, as described herein, may be implemented or executed, at least in part, by one or more computer systems. One such computer system is illustrated in FIG. 6. In various embodiments, computer system 600 may be a server, a mainframe computer system, a workstation, a network computer, a desktop computer, a laptop, a tablet computing device, media player, or the like. For example, in some cases, computer 600 may implement one or more steps of example process implementation 500 described above with respect to FIG. 5, and/or a computer system such as computer system 600 may be used as, or as part of, one or more of communications processing system 105, controlled-environment facility resident communication and/or media device (IFD 120 and IRD 125), a commissary provider system 165, AMS 175, resident account management system 180, vending machine controller 406, and/or the like. In various embodiments two or more of these computer systems may be configured to communicate with each other in any suitable way, such as, for example, via a network (e.g., in FIG. 1, devices and systems 105, 120, 125, 130 175 are illustrated as communicating via (local area) network 185.

As illustrated, example computer system 600 includes one or more processors 610 coupled to a system memory 620 via an input/output (I/O) interface 630. Example computer system 600 further includes a network interface 640 coupled to I/O interface 630, and one or more input/output devices 650, such as video device(s) 660 (e.g., a camera), audio device(s) 670 (e.g., a microphone and/or a speaker), and display(s) 680. Computer system 600 may also include a cursor control device (e.g., a mouse or touchpad), a keyboard, etcetera. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In various embodiments, computer system 600 may be a single-processor system including one processor 610, or a multi-processor system including two or more processors 610 (e.g., two, four, eight, or another suitable number). Processors 610 may be any processor capable of executing program instructions. For example, in various embodiments, processors 610 may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processors 610 may commonly, but not necessarily, implement the same ISA. Also, in some embodiments, at least one processor 610 may be a graphics processing unit (GPU) or other dedicated graphics-rendering device.

System memory 620 may be configured to store program instructions and/or data accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described in connection with FIGS. 1 through 5, above, may be stored within system memory 620 as program instructions 625 and data storage 635, respectively. In other embodiments, program instructions and/or data may be received, sent or stored upon different types of computer-accessible media or on similar media separate from system memory 620 or computer system 600. Generally speaking, a computer-readable medium may include any tangible or non-transitory storage media or memory media such as magnetic or optical media—e.g., disk or CD/DVD-ROM coupled to computer system 600 via I/O interface 630, Flash memory, random access memory (RAM), etcetera. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via network interface 640.

In some embodiments, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any suitable protocol, timing or other data transformations to convert data signals from one component (e.g., system memory 620) into a format usable by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. In addition, in some embodiments, some or all of the functionality of I/O interface 630, such as an interface to system memory 620, may be incorporated into processor 610.

Network interface 640 may be configured to allow data to be exchanged between computer system 600 and other devices attached to a network, such as other computer systems, or between nodes of computer system 600. In various embodiments, network interface 640 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

As shown in FIG. 6, memory 620 may include program instructions 625, configured to implement certain embodiments described herein, and data storage 635, comprising various data accessible by program instructions 625. In an embodiment, program instructions 625 may include software elements corresponding to one or more of the various embodiments illustrated in the above figures. For example, program instructions 625 may be implemented in various embodiments using any desired programming language, scripting language, or combination of programming languages and/or scripting languages (e.g., C, C++, C#, JAVA®, JAVASCRIPT®, PERL®, etcetera). Data storage 635 may include data that may be used in these embodiments. In other embodiments, other or different software elements and data may be included.

A person of ordinary skill in the art will appreciate that computer system 600 is merely illustrative and is not intended to limit the scope of the disclosure described herein. In particular, the computer system and devices may include any combination of hardware or software that can perform the indicated operations. Additionally, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system configurations.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A controlled-environment facility vending machine disposed in a controlled-environment facility, the controlled-environment facility vending machine comprising:
a vending mechanism configured to selectively vend one or more selected items; and
a vending controller comprising:
at least one processor; and
a memory coupled to the at least one processor, the memory configured to store program instructions executable by the at least one processor to cause the vending controller to:
accept, under control of a controlled-environment facility communications processing system and/or a controlled-environment facility administration and management system, from a controlled-environment facility resident communication and/or media device adapted to communicate only via a controlled-environment facility network under control of the controlled-environment facility communications processing system and/or the controlled-environment facility administration and management system, an order from a controlled-environment facility resident, placed via the controlled-environment facility resident communication and/or media device;
verify, under control of the controlled-environment facility administration and management system, the order conforms with resident restrictions applicable to the controlled-environment facility resident
verify presence of the controlled-environment facility resident at the vending machine; and
cause the vending mechanism to dispense one or more items specified in the order, to the controlled-environment facility resident.

2. The controlled-environment facility vending machine of claim 1, wherein the program instructions further cause the vending controller to accept identification information from the resident to verify the presence of the resident at the vending machine and restrict dispensing of the one or more items specified in the order, to the resident.

3. The controlled-environment facility vending machine of claim 1, wherein the program instructions further cause the vending controller to collect at least one biometric identifier from the resident to verify the presence of the resident at the vending machine and restrict dispensing of the one or more items specified in the order, to the resident.

4. The controlled-environment facility vending machine of claim 1, further comprising at least one radio frequency reader operatively coupled to the vending controller, and wherein the program instructions further cause the vending controller to employ the reader to detect a radio frequency identification tag associated with the resident to verify the presence of the resident at the vending machine and restrict dispensing of the one or more items specified in the order, to the resident.

5. The controlled-environment facility vending machine of claim 4, wherein the radio frequency identification tag is disposed in an article worn by the resident.

6. The controlled-environment facility vending machine of claim 1, further comprising at least one near field communication device operatively coupled to the vending controller, and wherein the program instructions further cause the vending controller to employ the near field communication device to exchange data with a near field communication device associated with the resident to verify the presence of the resident at the vending machine and restrict dispensing of the one or more items specified in the order, to the resident.

7. The controlled-environment facility vending machine of claim 6, wherein the near field communication device associated with the resident is part of a personal controlled-environment facility resident communication and/or media device associated with the resident.

8. The controlled-environment facility vending machine of claim 6, wherein the near field communication device associated with the resident is part of a personal controlled-environment facility resident communication and/or media device the resident used to place the order.

9. A method for vending one or more selected items by a controlled-environment facility vending machine, to a resident of a controlled-environment facility, the method comprising:
accepting, at a controlled-environment facility resident communication and/or media device adapted to communicate only via a controlled-environment facility network under control of a controlled-environment facility communications processing system and/or a controlled-environment facility administration and management system, an order from a resident of the controlled-environment facility for one or more items;
verifying, under control of the controlled-environment facility administration and management system, the order conforms with resident restrictions applicable to the controlled-environment facility resident;
transmitting the order, at least in part by the controlled-environment facility resident communication and/or media device, via the controlled-environment facility network, to a controlled-environment facility commissary vendor system;
enabling stocking of at least one of the one or more items in a controlled-environment facility vending machine specified in the order, by a commissary vendor associated with the commissary vendor system, in response to the order;
verifying presence of the resident at the controlled-environment facility vending machine, by the controlled-environment facility vending machine, under control of the controlled-environment facility communications processing system and/or the controlled-environment facility administration and management system; and
vending, by the controlled-environment facility vending machine, under control of the controlled-environment facility communications processing system and/or the controlled-environment facility administration and management system, one or more items specified in the order, to the resident.

10. The method of claim 9, wherein verifying the presence of the resident at the controlled-environment facility vending machine comprises, at least in part, accepting identification information from the resident, by the controlled-environment facility vending machine, restricting vending of the one or more items specified in the order, to the resident.

11. The method of claim 9, wherein verifying the presence of the resident at the controlled-environment facility vending machine comprises, at least in part, collecting at least one biometric identifier from the resident, by the controlled-environment facility vending machine, restricting vending of the one or more items specified in the order, to the resident.

12. The method of claim 9, wherein verifying the presence of the resident at the controlled-environment facility vending machine comprises, at least in part, detecting a radio frequency identification tag associated with the resident's person, by the controlled-environment facility vending machine, restricting vending of the one or more items specified in the order, to the resident.

13. The method of claim 9, wherein verifying the presence of the resident at the controlled-environment facility vending machine comprises, at least in part, establishing near field communications, by the controlled-environment facility vending machine, with a personal controlled-environment facility resident communication and/or media device associated with the resident and exchanging data, restricting vending of the one or more items specified in the order, to the resident.

14. A controlled-environment facility commissary goods order and distribution system comprising:
at least one controlled-environment facility resident communication and/or media device disposed in the controlled-environment facility and adapted to communicate only via a controlled-environment facility network under control of a controlled-environment facility communications processing system and/or a controlled-environment facility administration and management system, the at least one controlled-environment facility resident communication and/or media device comprising:
at least one controlled-environment facility resident communication and/or media device processor; and
a controlled-environment facility resident communication and/or media device memory coupled to the at least one controlled-environment facility resident communication and/or media device processor, the controlled-environment facility resident communication and/or media device memory configured to store program instructions executable by the at least one controlled-environment facility resident communication and/or media device processor to cause the controlled-environment facility resident communication and/or media device to:
accept an order from a resident of the controlled-environment facility for one or more items; and
transmit the order to the controlled-environment facility administration and management system, via the controlled-environment facility network;
a controlled-environment facility vending machine disposed in the controlled-environment facility, the controlled-environment facility vending machine comprising:
a vending mechanism configured to selectively vend one or more selected items; and
a vending controller comprising:
at least one vending controller processor; and
a vending controller memory coupled to the at least one vending controller processor, the vending controller memory configured to store program instructions executable by the at least one vending controller processor to cause the vending controller to, under control of the controlled-environment facility communications processing system and/or the controlled-environment facility administration and management system:
verify, under control of the controlled-environment facility administration and management system, the order conforms with resident restrictions applicable to the controlled-environment facility resident;
verify presence of the resident at the controlled-environment facility vending machine;
inquire from the controlled-environment facility administration and management system, in response to verifying presence of the resident at the controlled-environment facility vending machine, whether one or more items in the controlled-environment facility vending machine have been ordered by the resident for vending by the controlled-environment facility vending machine; and
cause the vending mechanism to dispense the one or more items in the order, to the resident.

15. The system of claim 14, wherein the vending controller program instructions further cause the vending controller to accept identification information from the resident to verify the presence of the resident at the vending machine and restrict dispensing of the one or more items specified in the order, to the resident.

16. The system of claim 14, wherein the vending controller program instructions further cause the vending controller to collect at least one biometric identifier from the resident to verify the presence of the resident at the vending machine and restrict dispensing of the one or more items specified in the order, to the resident.

17. The system of claim 14, wherein the controlled-environment facility vending machine further comprises at least one radio frequency reader operatively coupled to the vending controller, and wherein the vending controller program instructions further cause the vending controller to employ the reader to detect a radio frequency identification tag associated with the resident to verify the presence of the resident at the vending machine and restrict dispensing of the one or more items specified in the order, to the resident.

18. The system of claim 14, wherein the controlled-environment facility vending machine further comprises at least one near field communication device operatively coupled to the vending controller, and wherein the program instructions further cause the vending controller to employ the near field communication device to exchange data with a near field communication device associated with a personal controlled-environment facility resident communication and/or media device carried by the resident to verify the presence of the resident at the vending machine and restrict dispensing of the one or more items specified in the order, to the resident.

19. The system of claim 14, wherein the near field communication device associated with a personal controlled-environment facility resident communication and/or media device carried by the resident is part of the controlled-environment facility resident communication and/or media device the resident used to place the order.

20. A non-transitory computer-readable storage medium having program instructions stored thereon that, upon execution by a controller of a vending machine, causes the vending machine to:
accept or retrieve, under control of a controlled-environment facility communications processing system and/or a controlled-environment facility administration and management system, via a controlled-environment facility network under control of the controlled-environment facility communications processing system and/or the controlled-environment facility administration and management system, an order from a resident of a controlled-environment facility placed via a controlled-environment facility resident communication and/or media device adapted to communicate only via the controlled-environment facility network;
verify, under control of the controlled-environment facility administration and management system, the order conforms with resident restrictions applicable to the controlled-environment facility resident;
verify presence of the resident at the vending machine, within the controlled-environment facility; and
cause a vending mechanism of the vending machine to dispense one or more items specified in the order, to the resident.

21. The non-transitory computer-readable storage medium of claim 20, wherein the program instructions stored thereon are further executable by the vending machine controller to cause the vending machine to accept identification information from the resident to restrict dispensing of the one or more items specified in the order, to the resident.

22. The non-transitory computer-readable storage medium of claim 20, wherein the program instructions stored thereon are further executable by the vending machine controller to cause the vending machine to collect at least one biometric identifier from the resident to verify the presence of the resident at the vending machine and restrict dispensing of the one or more items specified in the order, to the resident.

23. The non-transitory computer-readable storage medium of claim 20, wherein the program instructions stored thereon are further executable by the vending machine controller to cause the vending machine to detect a radio frequency identification tag associated with the resident's person, restricting vending of the one or more items specified in the order, to the resident.

24. The non-transitory computer-readable storage medium of claim 20, wherein the program instructions stored thereon are further executable by the vending machine controller to cause the vending machine to establish near field communications with a personal controlled-environment facility resident communication and/or media device associated with the resident and exchange data to verify the presence of the resident at the controlled-environment facility vending machine and to restrict dispensing of the one or more items specified in the order, to the resident.
